(19) United States
(12) Patent Application Publication
(10) Pub. No.: US 2003/0071136 A1
(43) Pub. Date: Apr. 17, 2003

(54) Spill resistant drinking straw

(76) Inventor: Jason D. Ference, Asheville, NC (US)

Correspondence Address: Bruce E. Harang, PO Box 19161, Asheville, NC, 28815-1161, US

(21) Appl. No.: 09/977,927

(22) Filed: Oct. 15, 2001

(51) Int. Cl. A61J 15/00

(52) U.S. Cl. 239/33

(57) ABSTRACT

The invention provides spill-resistant drinking straws which are normally in a substantially sealed state such that liquid is substantially prevented from flowing through the straw, but which can be caused to open by the normal sucking action associated with the use of a straw to drink from a container.

### BACKGROUND OF THE INVENTION

1. Field of the Invention

The invention relates to a spill-resistant drinking straw. More specifically, the invention relates to a drinking straw, which is normally maintained in a closed position but which opens to allow fluid passage upon normal drinking action.

2. Description of the Related Art

Aseptically packaged juices and other drinks have become popular grocery items in recent years. Typically, aseptically sealed packages are provided as a flexible container in the shape of, for example, a rectangular box or as a flexible pouch. The containers often are provided in combination with a beveled, pointed straw, which is used to puncture the seal of the package. If the container is being gripped firmly when the straw punctures the seal, liquid from the container is apt to squirt out of the container and up through the straw. Similarly, when the straw is sealed in the container through the seal, squeezing of the container can cause liquid to squirt out of the straw. If the container falls over, liquid will spill out of the container through the straw. Similar problems exist with respect to other types of containers in which a straw is inserted into a container such as a drinking cup through a relatively tightly fitting hole, in for example, a plastic lid.

Proposals for remedying the problem of liquids squirting from the straw of flexible containers have been directed to strengthening the container walls so that the container is not so easily deformed. This solution would add to the cost of the container. An alternative solution has been the provision of hard plastic cases adapted to fit around the outside of the rectangular box packages. This successfully prevents deformation of the package when it is squeezed. But the plastic shell must be purchased separately by the consumer or be provided separately by the manufacturer or retailer of the packaged liquid. Another solution has been to provide a straw that is normally closed off by being bent to such an angle that the straw walls crimp and seals the straw. However, this solution requires additional expense in providing structures that will hold the straw in closed position and manually allow for repositioning the straw to the open position.

U.S. Pat. No. 3,438,527 to Gamblin, Jr. proposes a solution to the problem of liquid spillage through a straw seated in a container. According to the disclosure of this patent, a drinking straw is provided with a one-way, one-piece flow valve to normally prevent flow of liquid into the straw. The application of suction interiorly of the straw is said to collapse an elastic member permitting fluid to flow. Termination of the suction is said to permit the elastic member to re-expand and seal the straw. The elastic member is attached to the straw at the entrance end of the straw or is disposed within and completely across the interior of the straw.

U.S. Pat. No. 4,291,814 to Conn discloses a beverage container that includes a built-in straw. According to the proposal of this patent, a container is provided with an internal vertical tube and an external tube or straw that connects to the internal vertical tube. The straw can be used to seal the container by turning, which results in disalignment of portholes in the external and internal tubes. Further turning of the external tube aligns the portholes allowing the tube to be used as a drinking straw.

U.S. Pat. No. 4,714,173 to Ruiz proposes a leak proof closure for containers such as plastic or paper cups used primarily in fast food restaurants. A special container lid is provided with an orifice through which a straw can be inserted and the lid also includes an anchorage for engaging the drinking end of the straw. After the straw has been inserted through the orifice, it is bent at a location above the orifice and the drinking end of the straw is engaged with the anchorage member, thereby securing the straw in a bent position and preventing leakage through the straw in the event that the container is knocked over.

U.S. Pat. No. 5,052,614 to Xuan proposes a modified drinking straw having one end with ear-shaped extrados or expanded portion insertable into a modified straw hole on a beverage-containing package. The package must have an outer carrier layer and an inner foil sealing layer to generate necessary air exchange passages between said straw and said sealing layer after inserting said straw into said beverage-containing package.

U.S. Pat. No. 5,201,460 to Caines proposes a leak resistant closure of straws for use in aseptically packaged juices and other drinks. A special repeatedly deformable straw is proposed which is normally held in a closed position through the use of a biasing means that keeps the straw normally bent to such an angle as to deform the straw wall and form a seal. The straw is opened manually before use to allow liquid to flow under normal suction during drinking through the straw.

These and other known proposals for reducing spillage involve various shortcomings including difficulty of manufacture and/or the necessity for modification of the container or a closure member for the container, or the addition of a sealing element to hold the straw in a normally closed position.

### SUMMARY OF THE INVENTION

The invention provides a spill-resistant straw, which has inexpensive manufacturability, and which can be used with any of various known containers and container-types without requiring container modification. The straw of the invention can prevent or minimize the squirting of liquid upwardly through the straw when the container is squeezed and/or the spillage of liquid out of the container when the container is tipped over. In one preferred embodiment the spill-resistant drinking straw of the invention comprises a tubular drinking straw having a spill-resisting membrane which is normally closed thereby substantially preventing liquid flow, which may be repeatedly opened upon application of suction to said spill-resistant drinking straw thereby allowing liquid flow, and which repeatedly returns to a normally closed position upon removal of suction to said spill-resisting drinking straw. In another preferred embodiment the invention comprises a spill-resisting membrane containing sleeve, and a tubular drinking straw section attached to each end of said sleeve, said spill-resistant membrane, within said sleeve, being normally closed thereby substantially preventing liquid flow, which may be repeatedly opened upon application of suction to said spill-resistant drinking straw thereby allowing liquid flow, and which repeatedly returns to a normally closed position upon removal of suction to said spill-resisting drinking straw. In a further preferred embodiment of the invention comprises a spill-resisting membrane containing cap, and a tubular drinking straw section attached to the open end of said cap, said spill-resistant membrane, comprising the closed end of said cap, said spill-resistant membrane being normally closed thereby substantially preventing liquid flow, which may be repeatedly opened upon application of suction to said spill-resistant drinking straw thereby allowing liquid flow, and which repeatedly returns to a normally closed position upon removal of suction to said spill-resisting drinking straw.

### BRIEF DESCRIPTION OF THE DRAWINGS

In the drawings which form a portion of the original disclosure of the invention:

FIGS. 1, 2, 5, & 6 are side views in section of four respective embodiments of the spill-resistant drinking straw comprising the present invention.

FIGS. 3 & 4 are perspective views of two respective embodiments of the spill-resistant drinking straw comprising the present invention.

FIGS. 7-10 are partial cross-sectional views of FIG. 1 taken substantially along line A-A showing four respective embodiments of the spill-resistant drinking straw comprising the present invention.

### DESCRIPTION OF THE PREFERRED EMBODIMENTS OF THE INVENTION

Various preferred embodiment of the invention are described in the following detailed description. It is to be understood however, that the invention is not limited to its preferred embodiments; to the contrary, the invention includes various alternatives, modifications and equivalents within its spirit and scope as will be apparent to the skilled artisan.

One preferred embodiment of the invention comprises a spill-resistant drinking straw comprises, a tubular drinking straw having a spill-resisting membrane which is normally closed thereby substantially preventing liquid flow, which may be repeatedly opened upon application of suction to said spill-resistant drinking straw thereby allowing liquid flow, and which repeatedly returns to a normally closed position upon removal of suction to said spill-resistant drinking straw.

Another preferred embodiment of the invention comprises a spill-resistant drinking straw comprising: a spill-resisting membrane containing sleeve, and a tubular drinking straw section attached to each end of said sleeve, said spill-resistant membrane, within said sleeve, being normally closed thereby substantially preventing liquid flow, which may be repeatedly opened upon application of suction to said spill-resistant drinking straw thereby allowing liquid flow, and which repeatedly returns to a normally closed position upon removal of suction to said spill-resistant drinking straw.

A further preferred embodiment of the invention comprises a spill-resistant drinking straw comprising: a spill-resisting membrane containing cap, and a tubular drinking straw section attached to the open end of said cap, said spill-resistant membrane, comprising the closed end of said cap, said spill-resistant membrane being normally closed thereby substantially preventing liquid flow, which may be repeatedly opened upon application of suction to said spill-resistant drinking straw thereby allowing liquid flow, and which repeatedly returns to a normally closed position upon removal of suction to said spill-resistant drinking straw.

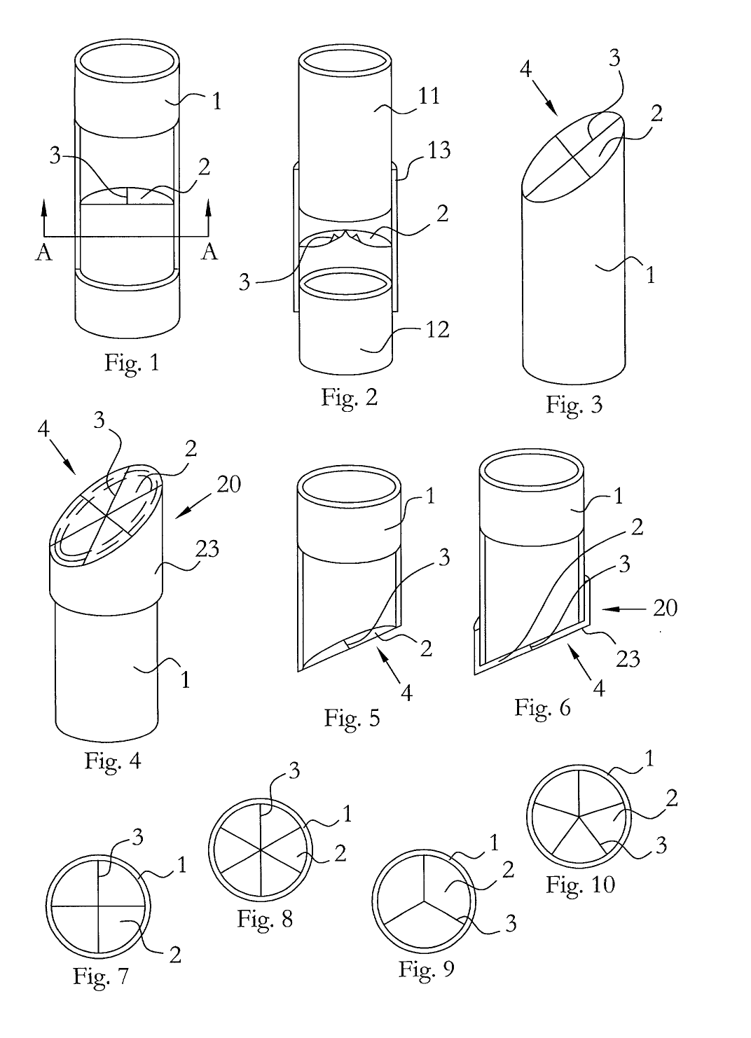

FIG. 1 illustrates one preferred spill-resistant drinking straw 1 according to the invention. The spill-resistant straw includes a tubular straw (hereinafter “straw”), of which a portion is shown, and which has a permanently affixed spill resisting segmented membrane within the interior of said straw, comprising pie-shaped segments 2 defined by slits 3 and the interior wall of straw 1. The said segmented membrane within said straw is normally maintained in a substantially sealed state by the resilience of said membrane segments 2.

FIG. 2 illustrates another preferred spill-resistant drinking straw according to the invention. FIG. 2 further illustrates the open position of the membrane when suction is applied by the user thereby allowing fluid to flow through the spill-resistant drinking straw. The spill-resistant drinking straw includes tubular straw portions 11 and 12, inserted into membrane containing sleeve 13. Said sleeve 13 comprising a tubular portion sized to accept one end of each of said tubular straw portions 11 and 12, and further containing a membrane comprising pie-shaped segments 2 defined by slits 3 and the interior wall of sleeve 13. The said segmented membrane within said sleeve 13 is normally maintained in a substantially sealed state by the resilience of said membrane segments 2. The tubular straw portions 11 and 12 of said spill-resistant drinking straw may be fixedly or detachably attached to said sleeve 13. It is to be further understood that in another preferred embodiment of the invention one of said tubular straw portions is fixedly attached to said sleeve 13 and the other of said tubular straw portions is detachably attached to said sleeve 13.

FIG. 3 illustrates another preferred spill-resistant drinking straw according to the invention. The spill-resistant drinking straw includes the distal end of a tubular straw portion 1 having a beveled pointed end 4. The opening at said distal beveled pointed end 4 being normally substantially sealed by a permanently attached membrane comprising pie-shaped segments 2 defined by slits 3 and the wall of tubular straw portion 1.

FIG. 4 illustrates yet another preferred spill-resistant drinking straw according to the invention. The spill-resistant drinking straw includes the distal end of a tubular straw portion 1 having a beveled pointed end 4. The opening at said distal beveled pointed end 4 being normally substantially sealed by an attached cap 20 comprising sleeve 23 sealed by a membrane comprising pieshaped segments 2 defined by slits 3 and the wall of sleeve 23. It is to be understood that said cap 20 may be fixedly or detachably attached to said distal beveled pointed end 4 of tubular straw 1.

FIG. 5 illustrates the preferred spill-resistant drinking straw of FIG. 3 in partial cross-section.

FIG. 6 illustrates the preferred spill-resistant drinking straw of FIG. 4 in partial cross-section.

FIGS. 7 through 10 illustrate preferred embodiments of membranes suitable for use in the present invention comprising pie-shaped segments 2 and slits 3. It is to be understood that the number of pie-shaped segments 2 is determined to allow for a normally substantially closed and spill-resistant membrane, which upon development of suction at the proximal end of said drinking straw deforms to create an opening, fluid flows past the deformed membrane segments 2 until suction is terminated. Termination of suction allows the pie-shaped segments 2 to return to their normally closed position.

It is to be understood that the proximal end of the spill-resistant drinking straw of the present invention is that end normally inserted into the mouth of the user and that the distal end of said spill-resistant drinking straw is that end which is inserted into the liquid containing container.

It is to be further understood that while the figures show the use of a cap at the distal end of the drinking straw, the cap may also be utilized at the proximal end of the drinking straw.

When maintained in the substantially sealed state shown in the Figures, the spill-resistant drinking straw 1 substantially eliminates spillage from a liquid container. Thus the beveled pointed distal end 4 of spill-resistant drinking straw 1 can be used to puncture a seal of a liquid container without causing liquid in the container to squirt upwardly through straw 1. Similarly, once straw 1 is seated within a relatively snug or tight orifice resulting from puncture of a seal, spillage of liquid out of the container is prevented or minimized. Additionally, the normally closed membrane segments 2 also prevent liquid from squirting up through the straw 1 when the user squeezes the container.

The spill-resistant drinking straw 1 illustrated in FIGS. 1-6 can be manufactured in various ways well understood in the art. For example, a conventional straw can be extruded from a polyolefin such as polypropylene in normal manner and cut into straight straw lengths. Two such straight straw lengths 11 and 12 may then be inserted into a membrane-containing sleeve 13. Said membrane-containing sleeve 13 may be made out of polyolefin or rubber or other suitable material. One or both straight straw lengths 11 and 12 may be inserted into said membrane-containing sleeve 13 at the time of manufacture or may be inserted into said membrane-containing sleeve 13 by the user. In the preferred embodiments of the present invention having integral membranes they may be composed of the same material as the straw either during the straw manufacture or as a separate manufacturing step.

The invention thus provides spill-resistant and squirt-resistant straws, which can be used with any of various well-known containers in order to prevent or minimize spilling of liquids. The spill-resistant straws provided by the invention can be readily and inexpensively manufactured according to any of various well-known plastic manufacturing processes. The straws of the invention are readily manufacturable from commercially available straws by attachment of a membrane or membrane-containing sleeve. Further, the straws of the invention may be manufactured having the spill-resisting membrane formed as an integral part of said straws using commercial processes well known to those skilled in the art. The straws of the invention are simple to use and can be substituted for conventional straws in any of the various known uses thereof. Nevertheless, the spill-resistant straws according to the invention reliably prevent accidental squirting and spillage of liquids through the straw.

The invention has been described in considerable detail with specific reference to various preferred embodiments thereof. However, variations and modifications can be made without departing from the spirit and scope of the invention as described in the foregoing specification and defined in the appended claims.

What is claimed is:

1. A spill-resistant drinking straw comprising: a tubular drinking straw having a spill-resisting membrane which is normally closed thereby substantially preventing liquid flow, which may be repeatedly opened upon application of suction to said spill-resistant drinking straw thereby allowing liquid flow, and which repeatedly returns to a normally closed position upon removal of suction to said spill-resistant drinking straw.

2. The spill-resistant drinking straw as claimed in claim 1 wherein the membrane is attached at a predetermined location along the length of the tubular straw.

3. The spill-resistant drinking straw as claimed in claim 1 wherein the membrane is integrally formed within the tubular straw.

4. The spill-resistant drinking straw as claimed in claim 1 wherein the membrane is integrally formed at the distal end of the tubular straw.

5. The spill-resistant drinking straw as claimed in claim 1 wherein the membrane is integrally formed at the proximal end of the tubular straw.

6. A spill-resistant drinking straw comprising: a spill-resisting membrane containing sleeve, and a tubular drinking straw section attached to each end of said sleeve, said spill-resistant membrane, within said sleeve, being normally closed thereby substantially preventing liquid flow, which may be repeatedly opened upon application of suction to said spill-resistant drinking straw thereby allowing liquid flow, and which repeatedly returns to a normally closed position upon removal of suction to said spill-resistant drinking straw.

7. A spill-resistant drinking straw comprising: a spill-resisting membrane containing cap, and a tubular drinking straw section attached to the open end of said cap, said spill-resistant membrane, comprising the closed end of said cap, said spill-resistant membrane being normally closed thereby substantially preventing liquid flow, which may be repeatedly opened upon application of suction to said spill-resistant drinking straw thereby allowing liquid flow, and which repeatedly returns to a normally closed position upon removal of suction to said spill-resistant drinking straw.

8. The spill-resistant drinking straw as claimed in claim 7 wherein the membrane containing cap is located at the distal end of said tubular straw.

9. The spill-resistant drinking straw as claimed in claim 7 wherein the membrane containing cap is located at the proximal end of said tubular straw.
